(19) United States
(12) Patent Application Publication
(10) Pub. No.: US 2024/0326550 A1
(43) Pub. Date: Oct. 3, 2024

(54) ROAD PAVER OR FEEDER VEHICLE WITH A FRESH AIR SYSTEM

(71) Applicant: Joseph Vögele AG, Ludwigshafen/Rhein (DE)

(72) Inventors: Bernhard ERDTMANN, Edingen Neckarhausen (DE); Stefan WEBER, Rödersheim-Gronau (DE); Johannes PONTIUS, Schmelz (DE); Jan RIFFEL, Mannheim (DE); Felix KEMPF, Mannheim (DE)

(73) Assignee: Joseph Vögele AG, Ludwigshafen/Rhein (DE)

(21) Appl. No.: 18/617,757

(22) Filed: Mar. 27, 2024

(30) Foreign Application Priority Data
Mar. 27, 2023 (EP) 23164331.3

(51) Int. Cl. B60H 1/00; B60H 1/24

(52) U.S. Cl. CPC B60H 1/0055; B60H 1/00407; B60H 1/246

(57) ABSTRACT

The disclosure relates to a road construction machine which is available in the form of a road paver or a feeder vehicle for a road paver, comprising at least one control station with at least one open side, wherein the control station comprises a control console for controlling and monitoring processes which can be carried out by means of the road construction machine, and a fresh air system with at least one fresh air opening, wherein the fresh air system is completely integrated in the control console. Furthermore, the disclosure relates to the use of a control console for fresh air generation and fresh air supply on a road construction machine.

### CROSS REFERENCE TO RELATED APPLICATIONS

This application claims foreign priority benefits under 35 U.S.C. § 119 (a)-(d) to European patent application number EP 23 164 331.3, filed Mar. 27, 2023, which is incorporated by reference in its entirety.

### TECHNICAL FIELD

The present disclosure relates to a road construction machine according to claim 1 and further relates to the use of a fresh air device according to claim 16.

### BACKGROUND

Conventionally, fresh air systems are used in closed vehicle cabs to filter air sucked in from outside the vehicle cab and to provide the filtered air inside the vehicle cab, which is separated from the outside, as fresh air for the occupants positioned inside. EP 3 463 947 B1 and U.S. Pat. No. 6,290,286 B1 disclose excavator vehicles with closed driver's cabs in which fresh air systems are installed.

DE 10 2020 123 723 A1 discloses a road paver with an air nozzle unit integrated in the roof of the driver's control station in order to generate an air curtain around the control station. Alternatively, an air curtain generated by the air nozzle unit is used in front of the paving screed to cover the auger chamber present there so that the vapors generated in the auger chamber by the transverse distribution of the paving material can be better sucked off. The principle of the air curtain partitioning of the driver's control station and the principle of the air curtain enclosure of the auger chamber in front of the paving screed help to prevent vapors from reaching the driver's control station and the external control station of the road paver.

Nevertheless, the air nozzle systems used for this purpose are cost-intensive in their structure and cannot easily be used as standardized units on different types of road pavers, as the roof structures formed on different types of pavers are of different sizes and their working widths can also differ. In addition, the air nozzle units tend to generate more noise at the driver's or screed operator's workplace.

### SUMMARY

An object of the disclosure is to improve the working conditions on a road paver or on a feeder vehicle for a road paver by means of or using simple, cost-effective means with regard to improved air quality.

This problem is solved by means of a road paver or a feeder vehicle according to claim 1. Furthermore, the problem is solved by using a fresh air supply according to claim 16.

The disclosure relates to a road construction machine which is provided in the form of a road paver or a feeder vehicle for a road paver. The road construction machine according to the disclosure comprises at least one control station with at least one open side. Consequently, the control station on the road construction machine according to the disclosure is not provided as a closed vehicle cabin. The control station according to the disclosure comprises at least one control console for controlling and monitoring processes that can be carried out by means of the road construction machine, as well as a fresh air system with at least one fresh air opening. According to the disclosure, the fresh air system is completely integrated in the control console.

According to the disclosure, therefore, the area of the open control station, which is already ventilated by the ambient air, can be additionally supplied with fresh air, whereby the overall air quality directly at the control console can be improved for a driver or operator positioned there. By using the control console itself as a fresh air generator, vapors and/or aerosols contained in the air in the area of the open control station can be reduced to a permissible level that is not considered hazardous to the health of the driver or operator.

The fresh air generation and output for this takes place directly via the control console of the control station. Thus, the fresh air device is completely, i.e., structurally and functionally, integrated into the control console. The fresh air system is therefore not perceived by the personnel as an separate module on the control station, but as an integral component of the control console provided on it and is therefore also used more reliably by the personnel.

Due to the fact that the fresh air system is integrated into the control console, the control console can be used in this form as a multifunctional standard module on different types of road pavers and feeders and, above all, is not dependent on type-specific, different constructions. The integrated construction results in a significant cost advantage over separate systems, which can also be a trip hazard at the control station.

By fully integrating the fresh air system into the control console, these modules together on the paver or feeder have a compact structure.

Operation of the fresh air system integrated into the control console is low-noise and energy-efficient due to short air ducts. In addition, thanks to the integral construction, there are no loose parts lying around which could impair operation. Rather, integrating the fresh air system into the control console results in a tidy and clear workplace, which has a preferred effect on machine operation. Another advantage is that due to the integrated construction, the driver's or operator's view is less restricted.

The control console forms a suitable module to accommodate the fresh air system without requiring noticeably more space at the control station. In particular, a user interface that is already used on the control console can be used for frontal fresh air supply.

Due to the installation of the complete fresh air system integrated into the control console, a potential surface for soiling or deposits can also be reduced at the control station, as the air ducts and fresh air openings of the fresh air system are integrated into the control console, that is, there are no components that can be soiled separately from the control console. Cleaning intervals for the control station therefore need to be carried out less frequently.

Furthermore, the fresh air supply provided directly from the control console also offers a protective function for the control console, in particular for the operating units used to control the road construction machine, because the fresh air supplied directly to the control console also creates a certain protective atmosphere on the control console, in particular on a control panel mounted on it, in particular has the effect of keeping the user interface of the control console clean. The direct fresh air output at the control console thus ensures both improved air quality for the operator working at the control console and an airspace-improved operating area for the control console, so that the control console can be kept clean for a longer period of time in this fresh air-enriched atmosphere and therefore remains more reliable in use.

A particular variant provides that the control console has a control panel with a user interface for controlling and monitoring processes that can be carried out by means of the road construction machine and a control panel support as a substructure for the control panel, wherein the fresh air system is at least partially integrated in the control panel and/or at least partially in the control panel support. The control panel and/or the control panel support for the control panel are thus available in a compact construction as fresh air modules. The control panel support is available for the control panel, in particular as a substructure or base to which the control panel is attached. Such a control panel support can be mounted in particular on a console slide or console guide in order to be able to adjust the control panel on the control station.

Preferably, controlling the fresh air system can be carried out by means of at least one operating unit integrated in the control panel and/or in the control panel support. Thus, the operation of the fresh air system is integrated into the user interface of the control panel and/or in the control panel support. It would be conceivable that in the user interface of the control panel and/or in the control panel support, for example, a rotary control is provided for setting a fresh air supply capacity.

One variant provides that the control panel has at least one touch display that is configured to control the fresh air system. In particular, the touch display is a component of an operating unit provided in the user interface of the control panel for controlling and monitoring processes which can be carried out by means of the road construction machine, for example an integral component of a tablet computer belonging to the control panel and removably mounted on it. The operating unit, in particular the tablet computer, can be configured to automatically adjust a fresh air supply capacity by the fresh air system with regard to an atmospheric condition detected at the control station, in particular the air quality present there.

In particular, at least one fresh air opening is formed in the user interface and/or in a surface formed by the control panel support, for example in a cladding formed thereon. Preferably, the control panel support is firmly connected to the control panel and thus always aligned with the operator, so that the operator can be supplied with fresh air from the front regardless of whether the fresh air flows out of the control panel and/or out of the control panel support positioned below it.

Preferably, several fresh air openings are provided in the user interface of the control panel and/or in a surface formed by the control panel support, for example in a cladding formed thereon. These make it possible for fresh air to escape frontally at various points of the control panel from the user interface created thereon and/or at various points from the control panel support. The fresh air openings on the control panel occupy part of the user interface, that is, they are integrated directly into the user interface and thus generate several fresh air flows directly from the user interface. These can be distributed over the user interface such that the atmosphere enriched with fresh air extends over a significant area of the user interface.

The fresh air openings can be distributed as desired on the user interface of the control panel and/or on the control panel support. A preferred variant provides that the fresh air openings are evenly distributed over the user interface. This ensures an even better supply of fresh air over the entire user interface. Especially in the case of control panels having a wide configuration, this allows the fresh air supply to be evenly distributed across the width.

It would be conceivable that several groups of fresh air openings are formed in the user interface, wherein the grouped fresh air openings are located in particular along lateral edge areas of the user interface, in each case. In these lateral edge areas, the fresh air flows formed therein can interact as fresh air walls, i.e., create a partitioning effect directly at the control panel against vapors and/or aerosols coming from outside. In addition, further fresh air openings can be provided in the user interface of the control panel between the fresh air openings grouped in the edge areas in order to provide a sufficient supply of fresh air between the lateral fresh air curtains.

Preferably, at least one row of fresh air openings arranged transversely to the direction of travel and/or at least one row of fresh air openings arranged along the direction of travel of the road construction machine are formed in the user interface. The fresh air openings arranged in rows within the user interface can divide the user interface into functional areas, thus ensuring a functionally structured, tidy user interface which can be easily operated by the operator or driver. In addition, the fresh air openings arranged in rows lead to an insignificantly enlarged user interface and thus to a compact construction of the control panel as a fresh air generator. A row of fresh air openings formed across the user interface can be located on the control panel at the top, in the middle or at the bottom along the user interface. Several transverse rows of fresh air openings are also conceivable.

One variant provides that there are several operating panels in the user interface, wherein at least one fresh air opening is positioned between the operating panels. This allows a frontal fresh air supply for the operator or driver to be formed between the operating panels from the user interface.

According to one embodiment of the disclosure, a total of three or four operating panels are formed in the user interface. In these variants, one of the operating panels can be configured as a touch display, which is configured in particular to control the fresh air system. According to one embodiment, at least two groups each formed by several fresh air openings can be positioned between adjacent operating panels. Thus, it is possible that fresh air flows from the user interface can be formed adjacent to each operating panel, so that the operator or driver benefits from a frontal fresh air supply in the entire area of the control panel. According to the embodiment, each group can contain two or three fresh air openings.

The adjacent operating panels can be equipped with specific operating units. One variant provides that in one of the operating panels there is an operating unit that can be used to set all the functions of the fresh air system, for example the touch display mentioned above.

The operating panels are arranged on the control panel, in particular in a 2×2 format, subdivided such that zones are left free between the operating panels in which the fresh air openings can be formed. Since free areas are constructively necessary between the operating panels to form the subdivided arrangement, the integration of the fresh air openings in these areas does not significantly increase the overall size of the user interface.

According to one embodiment, the fresh air system integrated in the control panel is configured both for a frontal fresh air supply to the operator or driver and for a lateral fresh air supply. With the frontal fresh air supply, the fresh air flow is directed towards the operator or driver. The lateral fresh air supply, on the other hand, is directed sideways from the control panel. Together, the frontal and lateral fresh air supply can expand the atmosphere enriched with fresh air at and around the control panel.

It would be conceivable that for forming the lateral fresh air supply at the user interface, areas of the control panel adjacent to the outside have further fresh air openings. The fresh air flows from these areas leading laterally away from the user interface can form an air barrier around the user interface, at least in some areas, to prevent vapors from rising from the rear side of the control panel into the operating area. The fresh air flows directed laterally away from the user interface can be of such intensity that a suction effect can be generated on the user interface or a negative pressure can be generated at least in some areas via the user interface in order to suck off air that has collected on it. This suction effect can be intensified by the fact that the fresh air openings used for this purpose are configured as nozzles, in particular flat nozzles, on the outside of the control panel.

Preferably, the control panel has a housing and the fresh air system has at least one fan mounted in the housing. The fan can be provided as a radial fan or an axial fan. By placing the fan of the fresh air system in the housing of the control panel, overall manufacturing costs can be reduced due to the integral construction. In particular, the fan can be supplied with power by an accumulator integrated in the control panel. Alternatively, the fan can be connected to a power supply integrated in the control panel. The fan can be driven electrically, pneumatically or hydraulically.

It would be useful if the housing of the control panel forms at least in sections an air duct connecting the fan to the fresh air opening or the fresh air openings. The air duct can be provided to guide fresh air to the fresh air opening integrated in the user interface of the control panel and/or to the fresh air opening integrated in the control panel support. Irrespective of whether the air duct supplies one or more fresh air openings in the control panel and/or in the control panel support with fresh air, it is integrated into the control console, i.e., it does not form a separate duct on the control station that is visible from the outside. A housing part forming the air duct can, in particular, form a part of the user interface that provides at least one fresh air opening, for example a housing part formed between the operating panels. As the fresh air system is structurally integrated into the housing of the control panel, this results in a space-saving and cost-reduced construction.

It would be conceivable that several air ducts lead from the fan within the control panel to respective groups of fresh air openings in order to supply them separately with fresh air. The air ducts can lead radially from the fan to the respective fresh air openings. One useful variant provides that the air duct or ducts are configured, at least in sections, for both frontal and lateral fresh air supply at the control panel. A separate fresh air supply could, for example, be provided along duct sections separated from each other by a common wall.

One variant provides that the fresh air system is configured to control the temperature of fresh air conveyed within the air duct. For this purpose, at least one cooling and/or heating unit could be installed in the control panel, in particular at least partially inside the air duct, in order to cool or heat the fresh air expelled by the fan.

It would even be conceivable that the fresh air could be heated by waste heat from the engine of the road construction machine in addition or alternatively to the temperature control by means of the cooling and/or heating unit. One variant provides in particular that, depending on a desired temperature of the fresh air made available to the driver or operator, a volume of air flow heated by the engine and provided to the fresh air system on its intake side can be regulated.

According to one embodiment, the fresh air heated to a desired temperature inside the control panel is guided inside the housing of the control panel such that at least one housing area of the control panel integrated in the user interface can be heated in a targeted manner. This could, for example, be a shelf formed in the user interface between the operating panels, in particular a depression that can be used as a shelf, in which the driver or operator can rest their hand.

According to one variant, a housing part delimiting the air duct is configured as a heat exchanger in order to bring the fresh air guided inside the air duct through this housing part to a desired temperature level. The heat exchanger can be made of an electrically conductive material.

Preferably, the air duct is formed by a pivotably mounted part of the housing. The pivotably mounted housing part can be equipped with several fresh air openings and can be pivoted about a substantially horizontal axis in the direction of the operator or driver in order to direct the fresh air openings directly towards him or her and to bring the fresh air openings closer to him or her.

It would be conceivable for the pivotably mounted part of the housing to form an upper housing part on the control panel, in which several fresh air openings arranged next to each other in a row at right angles to the direction of travel are formed. In the state pivoted towards the operator, the pivotable housing part could also be used as a sun visor for the user interface of the control panel so that the settings displayed on it can be read more easily.

One embodiment provides that at least one filter unit for the fresh air system is provided on a side of the control panel facing away from the user interface. This can be positioned or integrated in the housing of the control panel or in the control panel support. This filter unit can accommodate at least one replaceably configured filter element, which is placed upstream of an intake side of the fan so that filtered fresh air is blown out on its discharge side. It is conceivable to provide at least two filter elements in series one behind the other in the filter unit, for example a coarse particle filter and a fine particle filter arranged downstream, in order to clean the sucked-in air in several stages. The coarse particle filter can be configured as a coarse filter mat.

Furthermore, a variant in which two activated carbon filters and a third filter element serving as a pre-filter, for example a foam filter or a fleece filter, are used, would also be conceivable. These three filter elements can be firmly connected to each other for simplified and less error-prone assembly so that they can be installed and removed together.

For a compact construction, several filter elements could be arranged next to each other on the rear side of the control panel. In particular, the filter elements can be arranged in or on the control panel for even weight distribution.

It would be possible that the filter unit is connected to the intake side of the fan through an air duct that tapers towards the fan. This allows the air to be filtered in a better way, as the air sucked in passes through the filter(s) more slowly. It would be conceivable that the fresh air guided through this air duct can be tempered, in particular at the inlet of the air duct, that is, in a cross-sectionally widened area of the air duct. In this area, the filtered fresh air flow is comparatively slow and can therefore be heated better in this area.

The fresh air opening or all fresh air openings formed in the user interface and/or in the control panel support can have one or more lamellae, in particular as round air openings, each with at least one adjustable lamella. This allows the opening width of the fresh air openings or the round air openings and the direction of the fresh air emerging from the round air opening to be set. It would be conceivable that the operator or driver in case of a plurality of fresh air openings distributed over the user interface closes some of them by means of adjustable lamellae in order to get fresh air specifically from other, open fresh air openings. This would allow the fresh air supply to be directed to a specific area of the user interface. The fresh air openings could also be provided in a different shape, for example as rectangular openings.

A particularly preferred variant provides that the control console, together with the fresh air system integrated into it, is mounted on the control station so that it can be moved, adjusted in height, pivoted and/or rotated. The fresh air system integrated in the control console therefore follows all displacements of the control console and is thus always available for the fresh air supply directly at the control console, i.e., regardless of the position in which the control console is located. On small-format machine types in particular, it would be conceivable that the control console is mounted in a non-adjustable manner.

In particular, the control station is a driver's control station or an external control station on the road construction machine, that is, a driver's control station or an external control station on the road paver or a driver's control station on the feeder vehicle. A screed control station for a screed operator, whose control console is mounted on a side shifting device of the paving screed, is particularly suitable as an external control station on the outside of the road paver, on one or both sides of the paving screed.

It is conceivable that the control station configured as a driver's control station has a driver's operating platform on which the control console is mounted so that it can be moved, adjusted in height, pivoted and/or rotated. A control console positioned on the external control station can be height-adjustable, rotatable about a vertical axis and/or tiltable about a horizontal axis.

It would even be conceivable that the control console could be moved beyond the driver's operating platform in order to position the control console for a driver's seat console that is also moved beyond the driver's operating platform. In this position, the control panel is no longer located behind a windshield formed on the driver's control station, so that it is positioned in an exposed area laterally to the driver's control station, in which increased vapor can be generated from the material hopper of the road construction machine. In this area, the fresh air supply integrated on the control console is particularly useful for the driver in order to achieve sufficiently good air quality for the driver.

At the paving screed's external control station, the control console, in particular a control panel attached to it, can be used to control and monitor the processes carried out by the paving screed. The fresh air supply integrated on the control console, in particular on the control panel and/or on the control panel support, can improve the air quality for the screed operator located next to the paving screed. In addition to a frontal fresh air supply from the user interface of the control panel, a lateral fresh air flowing out of the control panel can shield the screed operator from vapors and/or aerosols from the auger chamber. In this way, both a fresh air barrier and a fresh air supply for the screed operator could be created at the control panel of the external control station.

According to one embodiment of the disclosure, the control console can be removed from the control station, in particular the control panel from the control panel support, without tools. The control panel can thus be easily removed and can, for example, be taken away from the construction site overnight by the driver or operator or stored on the construction site in a safe place, for example locked in a container.

It would be conceivable that the control panel could be connected to a charging station and/or a cleaning station for the filter unit of the integrated fresh air system when it is dismantled. By means of the charging station, a rechargeable battery used in the control panel for the fan of the fresh air system could be charged. By means of the cleaning station, it would be possible to clean the filter unit of the fresh air system installed on the control panel.

In practice, it would be particularly helpful if the fresh air system provided a position-dependent, material-dependent, driver- or operator-presence-dependent and/or process-dependent, automatically adaptable fresh air supply capacity. A dynamically adapted operation of the fresh air system in this respect could be carried out on the basis of detected measurements by means of at least one detection unit also integrated in the control console, in particular in the control panel and/or in the control panel support, for example by means of a distance measurement unit and/or a GPS data-based sensor system.

It would be conceivable that the fresh air supply capacity varies depending on a detected position of the control console on or relative to the control station. For example, the fresh air supply capacity could be increased or even be maximum if the control console, in particular the control panel, is positioned pivoted beyond the driver's operating platform of the driver's control station. One variant provides that the fresh air supply capacity is automatically increased when the screed operator removes the control panel attached to the external control station from the control panel support, in particular from a holder provided for this purpose, and thus moves close to the cross-distribution duct located in front of the paving screed, from which most of the vapors are generated during the paving process.

Preferably, the fresh air supply capacity can be automatically adjusted depending on the specific installation material, which tends to form different vapors and/or aerosols depending on its composition and/or temperature. Such material properties can be measured in the area of the material hopper. It would be conceivable that the specific material properties of the paving material could be detected by scanning a truck delivery bill, in particular using a scanning system integrated in the control panel, and/or on the basis of a web-based data transmission system that is set up between the road construction machine and a material supply chain supplying it.

The fresh air supply capacity could be adapted to an operating mode set on the road construction machine, for example automatically set to basic operation when the road construction machine is in paving or feeding mode. A reduced fresh air supply capacity could be set automatically if the road construction machine is only being moved on the construction site, that is, if no paving or feeding process is taking place.

By means of a driver or operator presence-dependent fresh air supply, the fresh air system could be switched off automatically when no operator or driver is present at the control console. For example, a fresh air supply at an external control station of the paving screed could be deactivated when the screed operator moves away from it. A distance measurement used for this purpose could be carried out using a sensor integrated into the control panel. Another possibility would be to switch off the fresh air system if the control panel is not used for a certain period of time or if no command is entered on it.

The disclosure further relates to the use of a control console installed on an open control station of a road construction machine for the generation and supply of fresh air. As an open control station is meant an area of a driver or an operator of the road construction machine which is open to the environment on at least one side, that is, the opposite of a space enclosed on all sides, as formed by a conventional vehicle cab. At the open control station according to the disclosure, the atmospheric conditions for the driver or operator staying inside are thus comparable to those in the environment adjacent to the open control station.

Due to the fact that, according to the disclosure, fresh air is generated directly by means of the control console used on the open control station and, in particular, is discharged via a control panel of the control console and/or via a control panel support of the control console, the atmospheric conditions at the control station can be improved for the driver or operator positioned there. In particular, this improves the air quality.

Above all, means are used to generate and dispense fresh air, all of which are integrated into the control console. Even for the operation of the fresh air system, it is preferable to use operating units integrated exclusively in the control console.

Due to the fact that the control console available at the open control station is used for the fresh air generation and also for the fresh air supply, this can be manufactured as a multifunctional module as standard and used on various types of road construction machines.

### BRIEF DESCRIPTION OF THE DRAWINGS

In the following, the present disclosure is explained in more detail with reference to Figures:

FIG. 1 shows a road construction machine in the form of a road paver;

FIG. 2 shows a road construction machine in the form of a feeder vehicle for a road paver;

FIG. 3A shows a control panel for a control station;

FIG. 3B shows a sectional view of the control panel shown in FIG. 3A;

FIG. 4A shows another control panel for a control station;

FIG. 4B shows a sectional view of the control panel shown in FIG. 4A;

FIG. 5A shows another control panel for a control station;

FIG. 5B shows a sectional view of the control panel shown in FIG. 5A;

FIG. 6 shows a control console together with control panel and control panel support in an isolated view;

FIG. 7A shows another control console with a control panel for an external control station;

FIG. 7B shows the control panel shown in FIG. 7A in a state removed from its holder; and

FIG. 8 shows a schematic view of a road paver from the top view.

Identical technical components are identified with the same reference signs throughout the Figures.

### DETAILED DESCRIPTION

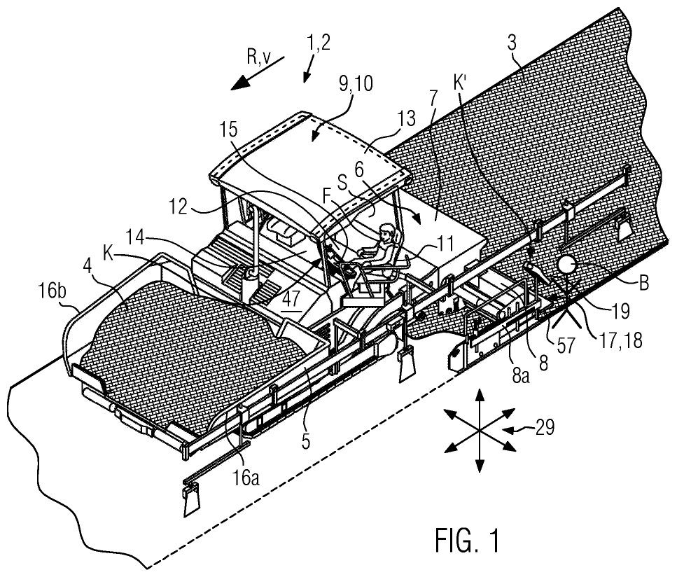

FIG. 1 shows a road construction machine 1 configured as a road paver 2 for producing a new paving layer 3. The road paver 2 produces the new paving layer 3 in the direction of travel R. For this purpose, the road paver 2 uses paving material 4, which is stored in a material hopper 5 formed on it. The paving material 4 stored in the material hopper 5 is transported by means of a longitudinal conveyor (not shown) against the direction of travel R to a paving screed 6, which is configured to compact the paving material 4 provided to it to form the new paving layer 3.

The paving screed 6 shown in FIG. 1 is configured as an extending screed. The paving screed 6 has a base screed 7 and lateral extending parts 8 for setting a desired paving width of the new paving layer 3.

The road paver 2 of FIG. 1 comprises a control station 9 for a driver F. The control station 9 is thus provided as a driver's control station 10. FIG. 1 shows that the driver's control station 10 is open to the side S and to the rear, that is, the atmospheric conditions, in particular the air quality, are present in the area surrounding the driver's control station 10 without any countermeasures being taken.

In FIG. 1, the driver F is seated on a pivotably configured seat console 11, by means of which he or she is pivoted out over a driver's operating platform 12 and positioned to the side of the driver's control station 10, so that he or she has a good view of the area next to the road paver 2. However, in this position pivoted beyond the driver's operating platform 12, the driver F is no longer seated behind a windshield 14 provided on the roof structure 13, so that he is more exposed to vapors and/or aerosols coming from the material hopper 5 as well as vapors and/or aerosols from the area of the paving screed 6.

On the driver's control station 10 of the road paver 2, a control console K with a control panel 15 is provided for the driver F. The control console K is attached to the structure of the driver's control station 10, in particular mounted on a console slide so that it can be moved transversely. The control panel 15 is configured for controlling and monitoring processes that can be carried out by means of the road paver 2. For example, the driver F can set the speed v of the road paver 2 in the direction of travel R on the control panel 15. Furthermore, the driver F can use the control panel 15 in particular to set the material hopper halves 16a, 16b, for example to pivot them inwards in order to move the installation material 4 stored in the material hopper 5 to the center of the longitudinal conveyor. In FIG. 1, however, the two material hopper halves 16a, 16b are adjusted completely outwards in order to be able to hold a maximum amount of installation material 4.

Furthermore, FIG. 1 shows another control station 17, which creates a workplace for a screed operator B on the outside of the paving screed 6 in order to control and monitor processes of the road paver 2, in particular the paving screed 6. This control station 17 created on the side shifting device 8a of the extending screed 8 is therefore an external control station 18.

In order to control and monitor the operation of the paving screed 6, including its extending screed 8, a further control console K′ with a control panel 19 is provided for the screed operator B at the external control station 18. As the screed operator B is located in the immediate vicinity of the paving material 4 processed by the extending screed 8, he or she is exposed to vapors and/or aerosols in this outdoor area.

Although the control stations 9, 17 on the road paver 2 shown in FIG. 1, which are open to the surroundings, are well ventilated, they are also reached by the vapors and/or aerosols generated during paving. As the control stations 9, 17 shown in FIG. 1 on the road paver 2 are standard on various road paver types, the problem of air quality for the driver F or screed operator B being impaired by vapors and/or aerosols exists for these control stations 9, 17 across all types.

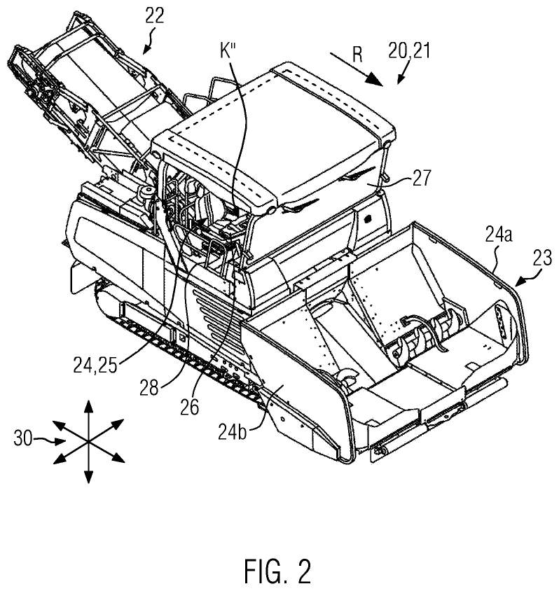

FIG. 2 shows another road construction machine 20 configured in the form of a feeder vehicle 21 for a road paver 2. Such a feeder vehicle 21 is used in practice to supply a road paver 2 as shown in FIG. 1 with paving material 4. For this purpose, the feeder vehicle 21 travels in front of the road paver 2 in the direction of travel R and throws paving material 4 into the material hopper 5 of the road paver 2 following behind it by means of a conveyor 22 formed on the feeder vehicle 21.

The feeder vehicle 21 of FIG. 2 has a material hopper 23 for accommodating paving material 4. The material hopper 23 can have material hopper halves 24a, 24b that are adjustable transversely to the direction of travel R. The conveyor 22 extends as far as the material hopper 23 and can therefore transport the paving material 4 stored in it out of the same, against the direction of travel R in the direction of the following road paver 2 and transfer it to the latter.

According to FIG. 2, the feeder vehicle 21 has a control station 24, which is provided as a driver's control station 25. This driver's control station 25 is also open to the sides and to the rear, so that vapors and/or aerosols can reach the driver F via the open sides of the driver's control station 25 and from the conveyor 22 mounted at the rear. A control console K″ with a control panel 26 for controlling and monitoring the processes carried out by the feeder vehicle 21 is mounted on the driver's control station 25 for the driver F. In FIG. 2, the control panel 26 is positioned behind a windshield 27 of the feeder vehicle 21, however, it can also be brought into a position next to the driver's control station 25, i.e., pivoted beyond its driver's operating platform 28.

In FIGS. 1 and 2, it is shown by means of the schematically shown adjustment axes 29, 30 that the respective control consoles K, K″ on the respective driver's control stations 10, 25 can be adjusted in any direction. In particular, the respective control consoles K, K″ together with the control panels 15, 26 mounted thereon can also be twisted or rotated and pivoted about the respective adjustment axes so that the control panels 15, 26 can be brought into a desired position.

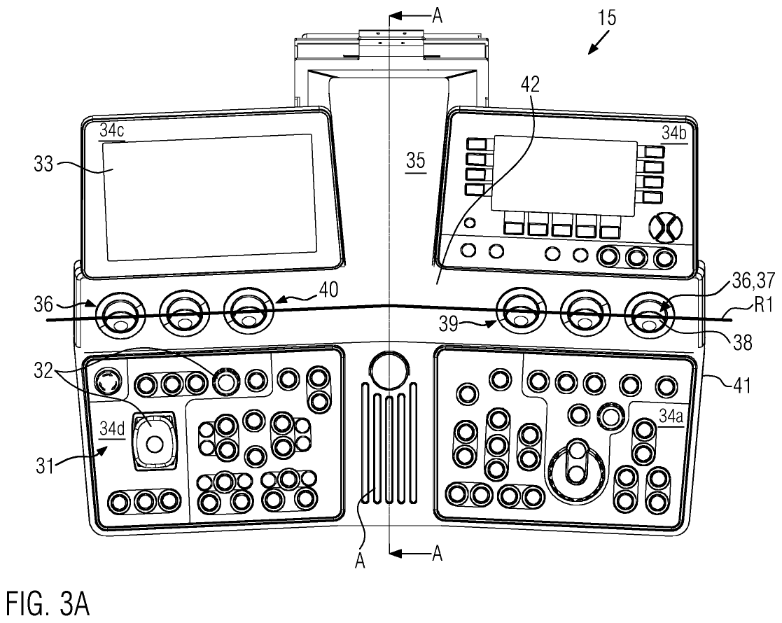

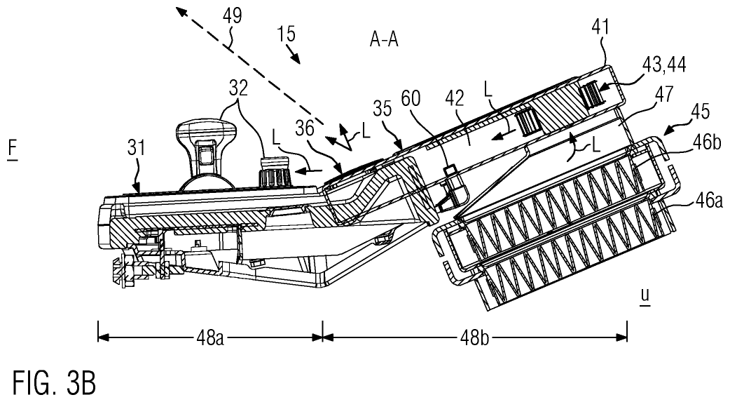

FIG. 3A shows a first variant of the control panel 15 of the road paver 2. The control panel 26 of the feeder vehicle 21 can be similarly configured. The control panel 15 of FIG. 3A has a user interface 31 with a plurality of operating units 32, by means of which the operation of the road paver 2 can be controlled. According to FIG. 3A, a touch display 33 is provided as an operating unit 32 on the control panel 15. It would be conceivable that the touch display 33 is part of a tablet computer mounted removably on the control panel 15.

The control panel 15 of FIG. 3A has a total of four operating panels 34a, 34b, 34c, 34d. Alternatively, the control panel 15 could also have only three of them, for example the operating panels 34a, 34b, 34d, that is, without the operating panel 34c formed with the touch display 33. Furthermore, the control panel 15 comprises a fresh air system 35 integrated therein with a plurality of fresh air openings 36 formed in the user interface 31. In FIG. 3A, the fresh air openings 36 are each formed as round air openings 37 and have at least one adjustable lamella 38. The lamellae 38 can be used to set a desired flow direction for the fresh air supply. In addition, the lamellae 38 can be used to close the round air openings 37.

FIG. 3A shows that a group 39 of three fresh air openings 36 are arranged next to each other in row R1 between the operating panels 34a, 34b. According to this arrangement, a further group 40 of fresh air openings 36 is formed between the operating panels 34c, 34d in the user interface 31. This essentially provides a fresh air supply across the entire width of the control panel 15. The driver F, positioned behind the control panel 15 in the direction of travel R, thus benefits directly at his workplace from an improved air quality enriched with fresh air.

In particular, the fresh air supply takes place independently of a position or set location of the control panel 15, 26 on the respective driver's control stations 10, 25, so that the fresh air supply is automatically present at the location of the control panel 15, 26.

The control panel 15 of FIG. 3A has a housing 41 in which an air duct 42 of the fresh air system 35 is integrated. The air duct 42 directs the fresh air to the fresh air openings 36 so that it can flow out there.

According to FIG. 3A, the fresh air openings 36 are evenly distributed over the user interface 31. This allows the driver F to set the fresh air supply to the two operating panels 34a, 34b by closing the group 40 of fresh air openings 36 or to set the fresh air supply to the two operating panels 34c, 34d by closing the group 39 of fresh air openings 36. The configuration shown in FIG. 3A thus allows the fresh air supply to be set either at the two operating panels 34a, 34b or at the two operating panels 34c, 34d.

FIG. 3A further shows a shelf A, which is formed between the operating panels 34a, 34d in the housing 41.

FIG. 3B shows a section A-A through the control panel 15 shown in FIG. 3A. According to FIG. 3B, the fresh air system 35 integrated in the control panel 15 has a fan 43, which is configured as a radial fan 44. The fresh air system 35 further comprises a filter unit 45 with filter elements 46a, 46b installed therein. The filter element 46a can be configured as a coarse particle filter. The filter element 46b positioned downstream can be a fine particle filter. Air is sucked in from the environment U of the control panel 15 through the filter unit 45 by means of the fan 43. By means of the filter unit 45, purified air, i.e., filtered fresh air L, can be sucked in axially by the radial fan 44 and blown radially into the air duct 42 in order to be discharged at the fresh air openings 36. An air duct 47 formed between the filter unit 45 and the fan 43 has a tapered cross-section towards the fan 43.

Furthermore, FIG. 3B shows that the control panel 15 is divided into a lower, horizontally formed section 48a and an upper section 48b, which is inclined relative to the horizontal section 48a and has the fresh air openings 36. As a result, the fresh air openings 36 are aligned such that the fresh air L flowing out of them can be directed frontally towards the driver F, with the result that the fresh air L flows directly from the fresh air openings 36 towards the driver F. This direct flow is indicated by the reference sign 49.

Furthermore, FIG. 3B shows a cooling/heating unit 60 in schematic view in order to bring the fresh air L transported in the air duct 42 to a desired temperature level.

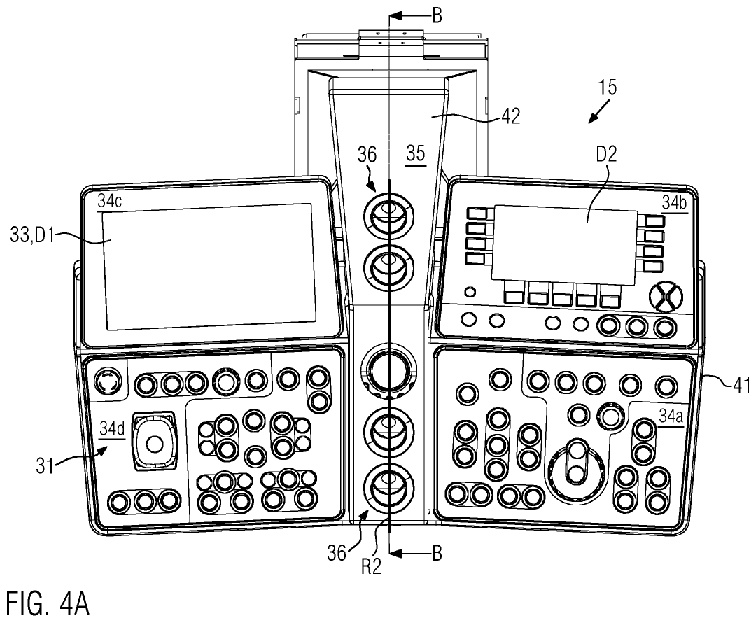

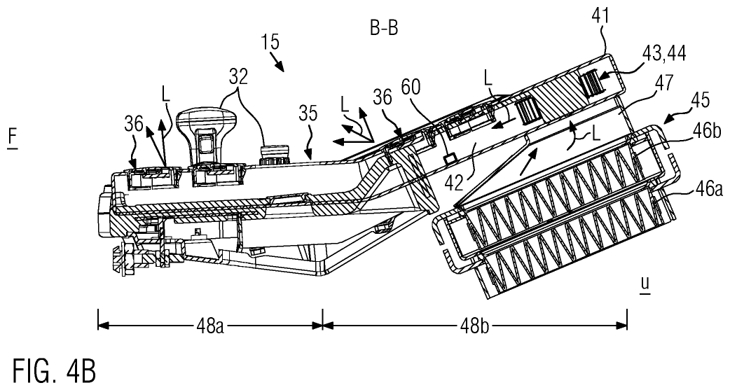

FIG. 4A shows a variant of the control panel 15 in which the fresh air openings 36 are positioned between adjacent operating panels 34a, 34d or 34b, 34c via the user interface 31. In this way, it is achieved that the control panel 15 has an overall more compact arrangement of the operating panels 34a, 34b or 34c, 34d. Since the operating panels 34b, 34c each have displays D1, D2, the respective halves of the control panel 15 essentially take the form of a notebook or laptop and are therefore easy for the driver F to operate.

According to FIG. 4A, the fresh air system 35 has an air duct 42 integrated in the housing 41 of the control panel 15, which is formed between the operating panels 34a, 34b and the operating panels 34c, 34d. The fresh air openings 36 contained therein are arranged one behind the other in a row R2 along the length of the control panel 15.

FIG. 4B shows a sectional view of the control panel 15 shown in FIG. 4A in the sectional course B-B.

According to FIG. 4B, the fresh air openings 36 formed in the lower section 48a of the control panel 15 allow the driver F to be supplied with fresh air L in his/her immediate vicinity. Overall, this results in a fresh air output from the user interface 31 that is particularly close to the driver F, so that the air quality in his working area can be improved particularly well.

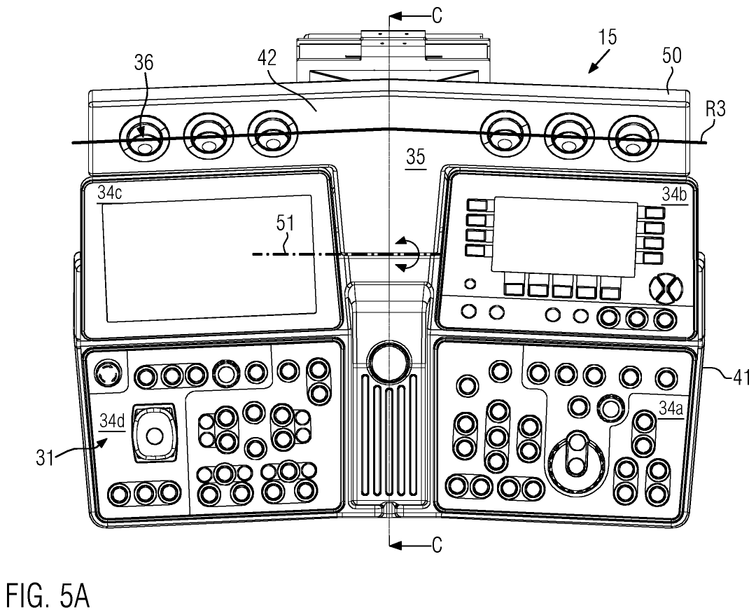

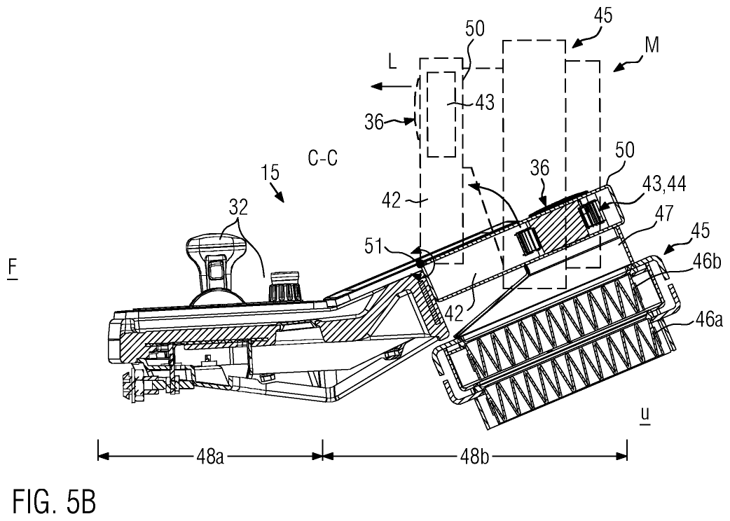

FIG. 5A shows the control panel 15 according to another variant. In this control panel 15, the fresh air openings 36 are positioned above the operating panels 34a-34d. The control panel 15 in FIG. 5A thus forms the fresh air system 35 in its upper section 48b. The housing 41 of the control panel 15 has a pivotable part 50, which forms the air duct 42 above the operating panels 34b, 34c. Alternatively, the part 50 of the housing 41 may be immovable, i.e., not pivotable.

The part 50 of the housing 41 shown in FIG. 5A is pivotably mounted about an axis 51 extending between the operating panels 34b, 34c. This allows the part 50 together with the fresh air openings 36 integrated therein to be erected towards the driver F such that the fresh air L flowing out of the fresh air openings 36 flows frontally in the direction of the driver F.

FIG. 5B shows the control panel 15 of FIG. 5A in section C-C. In this sectional view, a part 50 of the housing 41 is schematically shown folded up to provide the driver F with a better frontal supply of fresh air L from the fresh air openings 36. In this variant, the fresh air system 35 forms a pivoting module M integrated into the control panel 15. This pivoting module M allows fresh air L to flow out in a targeted manner in the direction of the driver F and on the other hand, the fresh air supply can overall be moved closer to the driver F. In addition, the pivoting module M can form a sun visor for the control panel 15 so that the settings displayed on it are easier to read.

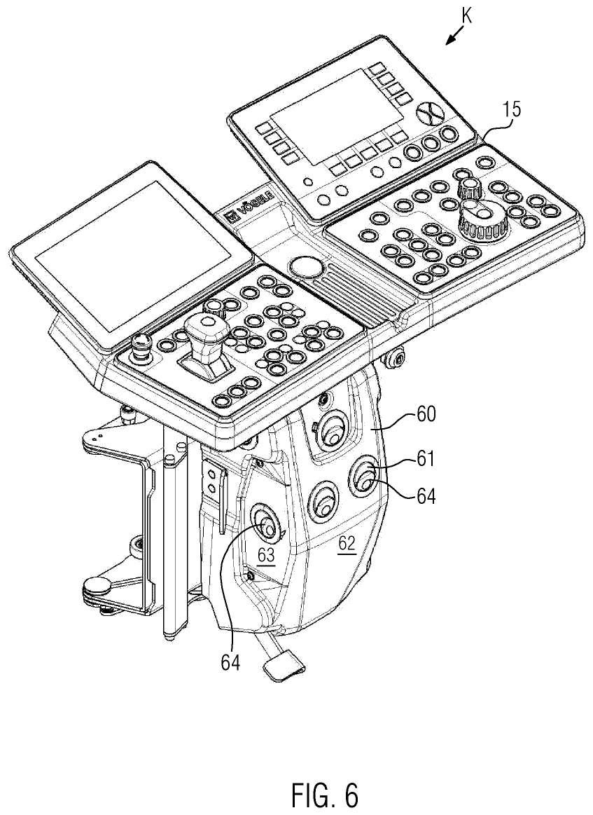

FIG. 6 shows the control console K in an isolated view. The control console K″ can have a comparable structure. The control console K has a control panel support 60 for the control panel 15. Several fresh air openings 61 are formed in the control panel support 60 in order to supply the operator or driver with fresh air from below.

Furthermore, FIG. 6 shows that there are fresh air openings 61 on the control panel support 60 both on its front 62 facing the operator and on its sides 63. The side fresh air openings 61 can also be aligned towards the operator or driver by means of lamellae 64.

Instead of the control panel 15 shown in FIG. 6, which does not provide any fresh air openings, a control panel 15 shown in FIGS. 3 to 5 with fresh air openings 36 could be used on the control panel support 60, resulting in a control console K in which fresh air openings 36, 61 are formed both in the control panel support 60 and in the control panel 15. Alternatively, the control panel support 60 shown in FIG. 6 could be configured without fresh air openings 61, wherein a control panel 15 provided with fresh air openings 36 as shown in FIGS. 3 to 5 can then be used. Instead of a control panel 15 with four operating panels as shown in FIG. 6, a control panel with fewer operating panels can also be attached to the control panel support 60.

The control panel support 60 shown in FIG. 6 is coupled to a console guide or slide (not shown) installed transversely on the control station 9 such that the control console K together with the control panel support 60 and the control panel 15 is mounted on the control station 9 so that it can be moved transversely. Furthermore, the control console K can be pivotably and/or rotatably mounted.

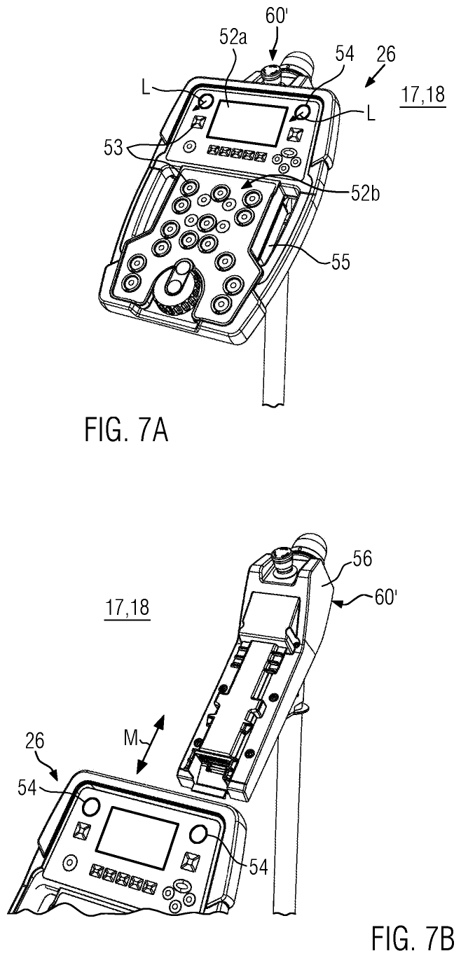

FIG. 7A shows the control console K′ together with the control panel 19, which is positioned on the paver 2 of FIG. 1 at the external control station 18 of the paving screed 6, in isolated view. The control panel 19 of FIG. 7A, which is positioned outdoors as shown, has two operating panels 52a, 52b. In the two operating panels 52a, 52b there are respective operating units 53 for controlling and monitoring the operation of the paving screed 6. In the upper operating panel 52a, two fresh air openings 54 are shown schematically in the upper corners in order to supply the screed operator B with fresh air L. These fresh air openings 54 are also part of a fresh air system 35 integrated in the control panel 15.

As an alternative to the illustration in FIG. 7A, the fresh air openings 54 could also be positioned between the operating panels 52a, 52b.

Furthermore, FIG. 7A shows that the control panel 15 has a handle 55 by means of which the control panel 15 can be released from a control panel support 60′, that is, removed from a holder 56 of the control panel support 60′, as shown in FIG. 7B. The screed operator B can thus remove the control panel 26 from the holder 56 without tools and carry it with him, for example to move it to another position on the paving screed 6.

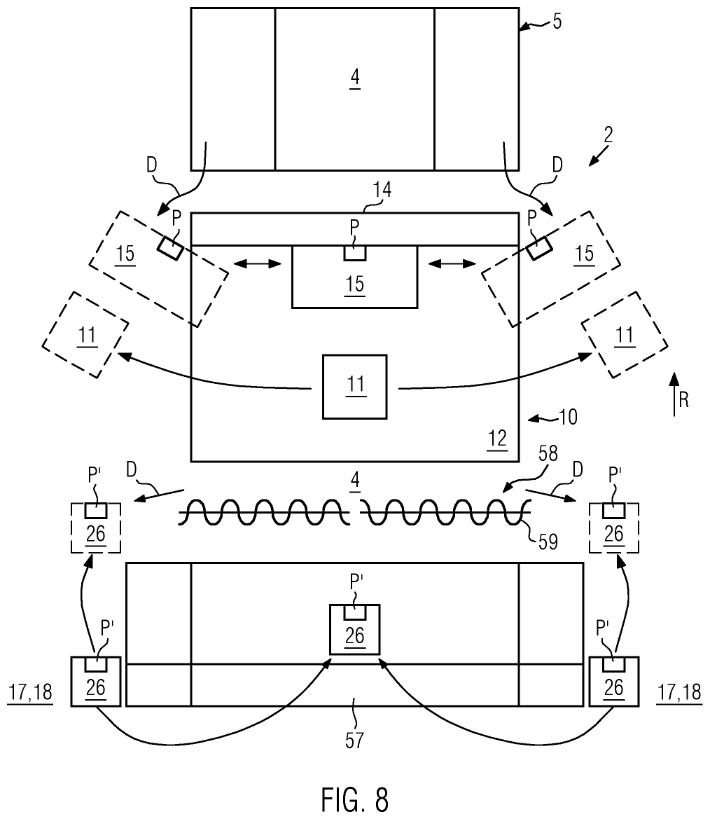

FIG. 8 shows the paver 2 in a schematic top view. FIG. 8 shows that the control panel 15 of the driver's control station 10 can be pivoted to the left and right beyond the driver's operating platform 12 when the driver F is positioned on the seat console 11 next to the driver's control station 10. In these zones next to the driver's operating platform 12, the driver F is increasingly exposed to vapors D and/or aerosols from the hopper 5. The control panel 15 according to the disclosure, in particular the fresh air system 35 integrated therein, can be configured to automatically set an increased fresh air generation and supply in these zones.

Furthermore, FIG. 8 shows that the screed operator B can take the control panel 26 removed from the external control station 18 to different areas. For example, the screed operator B can stand in the center of a walkway 57 of the paving screed 6 with the control panel 26. The screed operator B could just as well move with the control panel 26 in his hand to the auger chamber 58, in which a cross-distributing auger 59 spreads out the paving material 4 in front of the paving screed 6. In these areas, in which the screed operator B can be positioned with the removed control panel 26, vapors D and/or aerosols can also develop to an extreme degree. Therefore, by detecting that the control panel 26 is located in these zones, the fresh air generation and supply can be automatically increased by means of the control panel 26.

The increased fresh air generation and supply described in connection with FIG. 8 is based, for example, on a position detection system P, P′ integrated in the control panel 15, 26, by means of which the position of the control panel 15, 26 in the area of the road paver 2 can be detected and the fresh air generation and supply can be automatically increased or reduced in this respect.

As one skilled in the art would understand, the above-mentioned detection unit(s) (e.g., distance measurement unit and/or GPS data-based sensor system), the position detection system P, P′, as well an any other control, controller, control system, control station, control console, control panel, user interface, operating unit, touch display, unit, machine, apparatus, element, sensor, device, component, system, subsystem, arrangement, or the like described herein may individually, collectively, or in any combination comprise appropriate circuitry, such as one or more appropriately programmed processors (e.g. one or more microprocessors including central processing units (CPU)) and associated memory, which may include stored operating system software and/or application software executable by the processor(s) for controlling operation thereof and/or for performing the particular algorithms represented by the various functions and/or operations described herein, including interaction and/or cooperation between any such detection units, position detection systems, control, controller, control system, control station, control console, control panel, user interface, operating unit, touch display, unit, machine, apparatus, element, sensor, device, component, system, subsystem, arrangement, or the like. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

What is claimed is:

1. A road construction machine formed as a road paver or a feeder vehicle for a road paver, comprising a control station with at least one open side, wherein the control station comprises a control console for controlling and monitoring processes which can be carried out by the road construction machine, and a fresh air system with at least one fresh air opening, wherein the fresh air system is completely integrated in the control console.

2. The road construction machine according to claim 1, wherein the control console has a control panel with a user interface and a control panel support for the control panel, wherein the fresh air system is at least partially integrated in the control panel and/or at least partially in the control panel support.

3. The road construction machine according to claim 2, wherein the fresh air system is controllable by at least one operating unit integrated in the control panel and/or in the control panel support.

4. The road construction machine according to claim 2, wherein the control panel has at least one touch display which is configured to control the fresh air system.

5. The road construction machine according to claim 2, wherein at least one fresh air opening of the at least one fresh air opening is formed in the user interface and/or in a surface formed by the control panel support.

6. The road construction machine according to claim 2, wherein the control panel has a housing and the fresh air system has at least one fan mounted in the housing.

7. The road construction machine according to claim 6, wherein the housing forms, at least in sections, an air duct connecting the at least one fan to the at least one fresh air opening.

8. The road construction machine according to claim 7, wherein the fresh air system is configured for tempering fresh air conveyed within the air duct.

9. The road construction machine according to claim 7, wherein the air duct is formed by a pivotably mounted part of the housing.

10. The road construction machine according claim 2, wherein the fresh air system comprises at least one filter unit provided on a side of the control panel facing away from the user interface.

11. The road construction machine according to claim 2, wherein the control panel is removable from the control panel support without tools.

12. The road construction machine according to claim 1, wherein a fresh air opening of the at least one fresh air opening is formed with at least one adjustable lamella.

13. The road construction machine according to claim 1, wherein the control console together with the fresh air system integrated therein is mounted on the control station so as to be movable.

14. The road construction machine according to claim 13, wherein the control console is height-adjustable, pivotable and/or rotatable.

15. The road construction machine according to claim 1, wherein the control station is a driver's control station or an external control station.

16. The road construction machine according to claim 1, wherein the control console is removable from the control station without tools.

17. The road construction machine according to claim 1, wherein the fresh air system provides a position-dependent, material-dependent, operator-presence-dependent and/or process-dependent, automatically adjustable fresh air supply capacity.

18. A method of supplying fresh air at an open control station of a road construction machine, the method comprising generating and supplying the fresh air by a control console installed at the control station.
